(19) United States
(12) Patent Application Publication
(10) Pub. No.: US 2026/0091987 A1
(43) Pub. Date: Apr. 2, 2026

(54) PURE WATER PRODUCTION DEVICE

(71) Applicant: KURITA WATER INDUSTRIES LTD., Tokyo (JP)

(72) Inventor: Yasuharu MINATO, Tokyo (JP)

(73) Assignee: KURITA WATER INDUSTRIES LTD., Tokyo (JP)

(21) Appl. No.: 19/110,430

(22) PCT Filed: Sep. 15, 2023
(86) PCT No.: PCT/JP2023/033720

§ 371 Date: Mar. 11, 2025

(30) Foreign Application Priority Data
Oct. 14, 2022 (JP) 2022-165553

(51) Int. Cl. C02F 1/00; C02F 1/32; C02F 1/42; C02F 1/72; C02F 101/30; C02F 103/04

(52) U.S. Cl. CPC C02F 1/008; C02F 1/32; C02F 1/42; C02F 1/722; C02F 2101/30; C02F 2103/04; C02F 2209/001; C02F 2209/20; C02F 2209/22; C02F 2209/30; C02F 2209/40

(57) ABSTRACT

Provided is a pure water production device including an ultraviolet oxidation device for treating TOC components in water to be treated, in which an amount of water to be treated increases or decreases by 5 flow % or more with respect to a set value, and the pure water production device includes: a detection means for detecting an index directly or indirectly related to a concentration of H₂O₂ downstream or upstream of the ultraviolet oxidation device; and a control means for controlling an amount of ultraviolet rays in the ultraviolet oxidation device based on a detection value of the detection means.

### TECHNICAL FIELD

The present invention relates to a pure water production device including an ultraviolet oxidation device, and particularly to a pure water production device including an ultraviolet oxidation device in which the flow rate fluctuates in response to the amount of water used and other factors.

### RELATED ART

Conventionally, ultrapure water used in electronic industries such as semiconductor manufacturing is produced by treating raw water in an ultrapure water production device including a pretreatment device, a primary pure water device, and a secondary pure water device (subsystem) that treats the primary pure water.

Generally, an ultrapure water production device 1 is composed of three stages of devices as shown in FIG. 1, including a pretreatment device 2, a primary pure water device 3, and a secondary pure water device (subsystem) 4. In the pretreatment device 2 of such an ultrapure water production device 1, the raw water W undergoes pretreatment through filtration, coagulation sedimentation, precision filtration membrane, and other processes, primarily removing suspended solids.

The primary pure water device 3 includes, for example, a tank 11 for pretreated water W0, a reverse osmosis membrane device 12, an ultraviolet (UV) oxidation device 13, a regenerative ion exchange device (mixed bed or 4-bed 5-tower type, etc.) 14, and a membrane degassing device 15. It is be noted that 16 is a preheater. Here, most of the electrolytes, fine particles, and live bacteria in the pretreated water W0 are removed, and organic substances are decomposed.

The subsystem 4 includes, for example, a subtank 21 for storing the primary pure water W1 produced by the aforementioned primary pure water device 3, a pump 22 for feeding the primary pure water W1 stored in this subtank 21, an ultraviolet oxidation device 24 for treating this primary pure water W1, a platinum group metal catalyst resin tower 25, a membrane degassing device 26, a reverse osmosis membrane device 27, a non-regenerative mixed bed ion exchange device 28, and an ultrafiltration (UF) membrane 29 as a membrane filtration device. It is noted that 23 is a heat exchanger. In this subsystem 4, the ultraviolet oxidation device 24 oxidizes and decomposes trace amounts of organic substances (TOC components) contained in the primary pure water W1 by ultraviolet rays, the hydrogen peroxide generated by this ultraviolet irradiation is decomposed in the platinum group metal catalyst resin tower 25, and then dissolved gases such as DO (dissolved oxygen) that have been mixed in are removed by the downstream membrane degassing device 26. Subsequently, by treating through the reverse osmosis membrane device 27 and the non-regenerative ion exchange device 28, residual carbonate ions, organic acids, anionic substances, as well as metal ions and cationic substances are removed. Then, fine particles are removed by the ultrafiltration (UF) membrane 29 to produce ultrapure water (secondary pure water) W2, which is supplied to the use point 5 through the feed pipe 30, and unused ultrapure water is recirculated to the subtank 21 through the return pipe 31.

In the ultrapure water production device 1 as described above, the ultraviolet oxidation device 13 primarily aims to decompose TOC according to the following formula (1) by generating a wavelength of 185 nm. However, it is known that hydrogen peroxide (H₂O₂) is generated by the irradiation of ultraviolet rays.

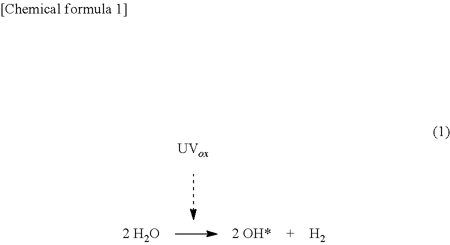

The hydrogen peroxide generated here, when flowing into downstream equipment, especially ion exchange devices (such as the regenerative ion exchange device 14, non-regenerative ion exchange device, or electrodeionization device), decomposes and generates DO (dissolved oxygen). Alternatively, hydrogen peroxide may decompose the ion exchange resin, generating TOC. In pure water production devices, it is often necessary to guarantee DO levels of <1 μg/L. Thus, a membrane degassing device 15 is installed downstream or upstream of the ion exchange device 14 to remove DO, or a platinum group metal catalyst resin tower is further installed upstream of the membrane degassing device 15 to completely decompose the hydrogen peroxide itself into oxygen.

Incidentally, as shown in FIG. 1, in the conventional ultrapure water production device 1, ultrapure water W2 is produced at the maximum amount used at the use point (POU) 5, and excess water is circulated and reused. However, in recent years, efforts to improve energy efficiency in pure water production devices have been promoted. As part of these efforts, by sending only the necessary amount of water according to the required water volume at the use point (POU) 5, instead of circulating the excess water as was done conventionally, technologies are being considered to reduce the operating energy of feed pumps, which consume a large amount of power in the pure water production device, especially the supply pump for the reverse osmosis membrane (RO).

### SUMMARY OF INVENTION

### Technical Problem

However, in the case of operating the pure water production device (primary pure water device 3) by increasing or decreasing the water production volume in response to the amount of water used at the use point 5, for example, when the water production volume decreases, the ultraviolet rays from the UV oxidation device become over-irradiated (the irradiation energy of the UV lamps in the ultraviolet oxidation device becomes excessive relative to the TOC load of the feed water), resulting in an increase in the generation amount of hydrogen peroxide. Consequently, the DO at the outlet of the ion exchange device downstream of the ultraviolet oxidation device 13 increases.

For example, FIG. 8 schematically shows an example of the impact due to flow rate fluctuation in a primary pure water device 3 including a ultraviolet oxidation device 13 and an ion exchange device 14. FIG. 8 illustrates the case of treating water to be treated Wx with a primary pure water device 3 including a ultraviolet oxidation device 13 and an ion exchange device 14 to obtain treated water Wz with a guaranteed value of DO<5 μg/L. Compared to the steady-state flow rate (100 m³/L), at a low flow rate (50 m³/L), the H₂O₂ in the treated water Wy after processing by the ultraviolet oxidation device 13 becomes high at 40 μg/L. As the assumed mass balance changes, there is a risk that the DO in the treated water Wz at the outlet of the ion exchange device 14 may become ≥5 μg/L. In other words, there is a problem that the guaranteed value of DO may not be met.

The present invention is made in view of the above-mentioned issues, and aims to provide a pure water production device provided with a ultraviolet oxidation device capable of suppressing the generation of hydrogen peroxide even when the amount of water to be treated fluctuates in response to the amount of water used, etc.

### Solution to Problem

In view of the above-mentioned objective, the present invention provides a pure water production device including an ultraviolet oxidation device for treating TOC components in water to be treated, in which an amount of water to be treated increases or decreases by 5 flow % or more with respect to a set value, and the pure water production device includes: a detection means for detecting an index directly or indirectly related to a concentration of H₂O₂ downstream or upstream of the ultraviolet oxidation device; and a control means for controlling an amount of ultraviolet rays in the ultraviolet oxidation device based on a detection value of the detection means (Invention 1).

According to this invention (Invention 1), it is generally known that the generation amount of H₂O₂ in a UV oxidation device correlates with the irradiation energy amount of the ultraviolet lamp per unit water volume. Thus, to reduce the generation amount of H₂O₂ that increases when the amount of water to be treated decreases, it is necessary to reduce the irradiation energy of the ultraviolet lamp. Specifically, when the amount of water to be treated in the pure water production device decreases by 5% or more, the amount of ultraviolet rays becomes excessive relative to TOC, and the concentration of H₂O₂ increases. Thus, by detecting the concentration of H₂O₂ downstream of the ultraviolet oxidation device and controlling the amount of ultraviolet rays in the ultraviolet oxidation device based on this detection value, it is possible to suppress the generation of hydrogen peroxide even when the amount of water to be treated fluctuates.

In the above-mentioned invention (Invention 1), it is preferable that the detection means is a flow meter, and the control means controls an amount of ultraviolet rays to increase or decrease in response to an increase or a decrease of a flow rate detection value of the flow meter (Invention 2).

According to this invention (Invention 2), the detection value of the flow meter represents the amount of water to be treated in the ultraviolet treatment device. Thus, with the same amount of ultraviolet rays, the concentration of H₂O₂ increases when the amount of water to be treated decreases. By controlling the ultraviolet treatment device to increase or decrease the amount of ultraviolet rays in response to the increase or decrease in the amount of water to be treated, it is possible to suppress the generation of hydrogen peroxide even when the amount of water to be treated fluctuates.

In the above-mentioned invention (Invention 1), it is preferable that the detection means is an H₂O₂ meter or a dissolved hydrogen meter provided downstream of an ultraviolet oxidation device, and the control means controls an amount of ultraviolet rays to increase or decrease in response to an increase or a decrease of a detection value of the H₂O₂ meter or the dissolved hydrogen meter (Invention 3).

According to this invention (Invention 3), when hydrogen peroxide increases, hydrogen is generated accordingly. Thus, by controlling the ultraviolet treatment device to increase or decrease the amount of ultraviolet rays in response to the increase or decrease of the measurement value from the H₂O₂ meter or the detection value from the dissolved hydrogen meter, it is possible to suppress the generation of hydrogen peroxide even when the amount of water to be treated fluctuates.

In the above-mentioned invention (Invention 1), it is preferable that the pure water production device includes an ion exchange device downstream of an ultraviolet oxidation device, the detection means is a dissolved oxygen meter provided downstream of the ion exchange device, and the control means controls an amount of ultraviolet rays to increase or decrease in response to an increase or a decrease of a detection value of the dissolved oxygen meter (Invention 4).

According to this invention (Invention 4), when H₂O₂ passes through the ion exchange device, it becomes H₂O and oxygen is generated, resulting in an increase in dissolved oxygen (DO). Thus, in the case where the pure water production device includes an ion exchange device downstream of the ultraviolet oxidation device, by detecting the dissolved oxygen concentration downstream of this ion exchange device and controlling the ultraviolet treatment device to increase or decrease the amount of ultraviolet rays in response to the increase or decrease of this dissolved oxygen detection value, it is possible to suppress the generation of hydrogen peroxide even when the amount of water to be treated fluctuates.

In the above-mentioned invention (Invention 1), it is preferable that power input per unit flow rate to the ultraviolet oxidation device is 0.01 to 0.3 kWh/m³, and an illuminance of the ultraviolet oxidation device is controllable in a range of 30% to 100% with a maximum value of the illuminance set as 100% (Invention 5).

According to this invention (Invention 5), by using an ultraviolet oxidation device with a wide range of illuminance control, it is possible to adjust the illuminance of the ultraviolet oxidation device in response to significant fluctuations in the amount of water to be treated and suppress the generation of hydrogen peroxide.

In the above-mentioned inventions (Inventions 1 to 5), a TOC measurement means and a flow meter may be provided upstream of the ultraviolet oxidation device (Invention 6).

According to this invention (Invention 6), by setting the amount of ultraviolet rays of the ultraviolet oxidation device in advance based on the flow rate of the treated water and the TOC concentration of the treated water in the ultraviolet oxidation device, it is possible to minimize the adjustment amount of the ultraviolet rays irradiation.

### Effects of Invention

According to the pure water production device provided with the ultraviolet oxidation device of the present invention, when the amount of water to be treated in the pure water production device fluctuates by 5% or more, especially when it decreases by 5% or more, the amount of ultraviolet rays becomes excessive relative to the TOC, resulting in an increase in the concentration of H₂O₂. Thus, by detecting the concentration of H₂O₂ downstream of the ultraviolet oxidation device and controlling the amount of ultraviolet rays in the ultraviolet oxidation device based on this detection value, it is possible to suppress the generation of hydrogen peroxide even when the amount of water to be treated fluctuates. This makes it easier to significantly vary the water production volume of pure water in the pure water production device.

### BRIEF DESCRIPTION OF DRAWINGS

FIG. 1 is a flow diagram showing an ultrapure water production device to which the pure water device of the present invention may be applied.

FIG. 2 is a flow diagram schematically showing a pure water production device according to the first embodiment of the present invention.

FIG. 3 is a flow diagram schematically showing a pure water production device according to the second embodiment of the present invention.

FIG. 4 is a flow diagram schematically showing a pure water production device according to the third embodiment of the present invention.

FIG. 5 is a flow diagram schematically showing a pure water production device according to the fourth embodiment of the present invention.

FIG. 6 is a schematic diagram showing the fluctuation of DO associated with water volume fluctuation in the pure water production device of the aforementioned embodiments.

FIG. 7 is a graph showing the relationship between the ultraviolet oxidation device and the generation amount of H₂O₂.

FIG. 8 is a schematic diagram showing the fluctuation of DO associated with water volume fluctuation in a conventional pure water production device.

### DESCRIPTION OF EMBODIMENTS

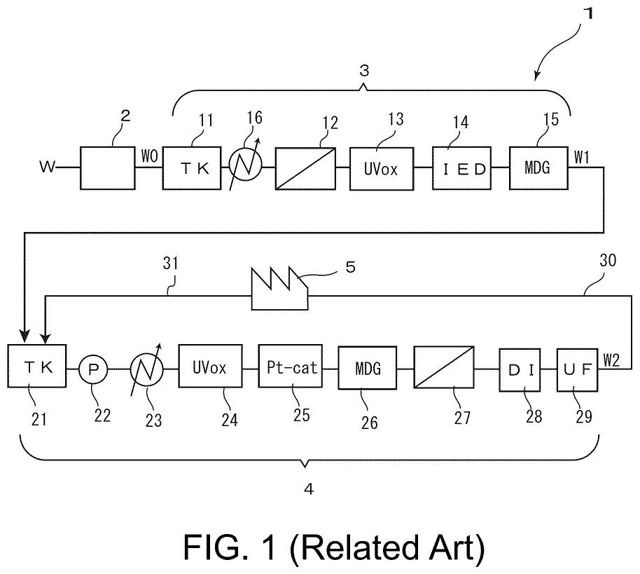

The pure water production device of the present invention is described below with reference to the drawings. The pure water production device of the present invention is characterized by the control of the ultraviolet oxidation device 13, and as for the overall configuration, it may be applied to the ultrapure water production device 1 shown in FIG. 1 described above. Thus, in the following embodiments, only the relevant configuration of the pure water production device (primary pure water device 3) is shown, and the rest are omitted.

### First Embodiment

### (Pure Water Production Device)

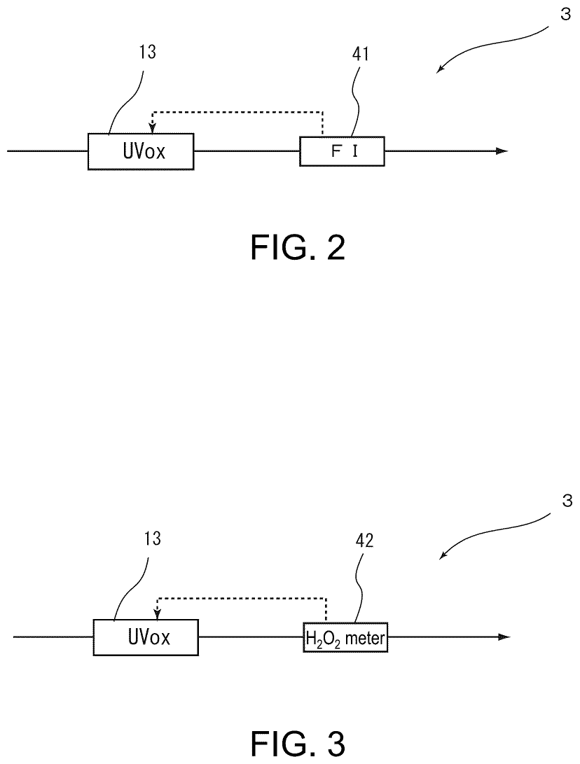

FIG. 2 schematically shows a pure water production device according to the first embodiment of the present invention. In this embodiment, a flow meter 41 is provided downstream of the ultraviolet oxidation device 13, and a control means (not shown) is provided that may control the amount of ultraviolet rays irradiated by the ultraviolet oxidation device 13 based on the detection value of this flow meter 41.

In this embodiment, it is preferable that the ultraviolet oxidation device 13 is composed of multiple blocks of ultraviolet lamps, with each block including multiple ultraviolet lamps, and may control the amount of ultraviolet rays irradiated in the ultraviolet oxidation device 13 over a wide range by controlling the number of lit blocks and adjusting the illuminance of the ultraviolet lamps in each block by the control means. Such an ultraviolet oxidation device 13 preferably has a power input per unit flow rate of 0.01 to 0.3 kWh/m³, and the illuminance control of the ultraviolet oxidation device is possible in the range of 30% to 100% with 100% as the maximum value. Specifically, the device may be configured by combining 5 blocks of ultraviolet lamps, each including one or more ultraviolet lamps, and making the illuminance of the ultraviolet lamps in each block adjustable in the range of 30% to 100%. With the number of lit blocks being 1 to 5, the ultraviolet oxidation device 13 may adjust the amount of ultraviolet rays irradiated in the range of 6 to 100% of the maximum value of the irradiation amount. As such an ultraviolet oxidation device 13, “JPW”, “JPH”, and “ZK-UV” manufactured by Photoscience Japan Corp. may be used, which may adjust both the illuminance of the ultraviolet lamps and the number of lit blocks. Further, “COX”, “WOX”, and “NWOX” manufactured by Chiyoda Kohan.,Ltd. are examples that only have the function of adjusting the illuminance of ultraviolet lamps. However, due to the wide adjustment range of the amount of ultraviolet rays irradiated, it is preferable to use devices that may adjust both the illuminance of the ultraviolet lamps and the number of lit blocks. Particularly, “JPW” and “ZK-UV” manufactured by Photoscience Japan Corp. are preferable in terms of high TOC decomposition performance.

### (Control Method of Ultraviolet Oxidation Device)

In such a pure water device, the amount of water to be treated is measured by the flow meter 41 downstream of the ultraviolet oxidation device 13, and feedback control is performed to increase the amount of ultraviolet rays irradiated in the ultraviolet oxidation device 13 if the amount of water to be treated increases compared to a predetermined reference amount, and to decrease the amount of ultraviolet rays if it decreases. This control of the amount of ultraviolet rays irradiated may be performed by measuring in advance the relationship between the standard amount of ultraviolet rays irradiated at the reference flow rate, the increase in undecomposed TOC accompanying the increase in the amount of water to be treated, and the generation amount of H₂O₂ accompanying the decrease in the amount of water to be treated, and responding accordingly.

It is noted that in the present embodiment, the flow meter 41 is provided downstream of the ultraviolet oxidation device 13, but it may also be provided on the inlet side for feedforward control. Furthermore, a TOC measurement means may be provided upstream of the aforementioned ultraviolet oxidation device 13, and the initial amount of ultraviolet rays irradiated in the ultraviolet oxidation device 13 may be set based on the amount of water to be treated by the ultraviolet oxidation device 13 and the measured value from the TOC measurement means.

### Second Embodiment

### (Pure Water Production Device)

FIG. 3 schematically shows a pure water production device according to the second embodiment of the present invention. In this embodiment, an H₂O₂ meter 42 is provided downstream of the ultraviolet oxidation device 13, and a control means (not shown) is provided that may control the amount of ultraviolet rays irradiated in the ultraviolet oxidation device 13 based on the detection value from this H₂O₂ meter 42.

### (Control Method of Ultraviolet Oxidation Device)

In such a pure water device, the H₂O₂ concentration of the treated water is measured by the H₂O₂ meter 42 downstream of the ultraviolet oxidation device 13. If the H₂O₂ concentration increases or shows an increasing trend, it is determined that the amount of ultraviolet rays irradiated is excessive, and the amount of ultraviolet rays irradiated in the ultraviolet oxidation device 13 is decreased. On the other hand, if the H₂O₂ concentration falls below a predetermined level, it is preferable to control the amount of ultraviolet rays irradiated in the ultraviolet oxidation device 13 to decrease. This is because not only is there concern about residual TOC if the H₂O₂ concentration is too low, but especially in an ultrapure water production device 1 as shown in FIG. 1, if the TOC concentration is lowered too much in the ultraviolet oxidation device 13 of the primary pure water device 3, the ultraviolet rays become over-irradiated for TOC in the ultraviolet oxidation device 24 of the subsystem 4, making it easier for H₂O₂ to be generated in the subsystem 4.

### Third Embodiment

### (Pure Water Production Device)

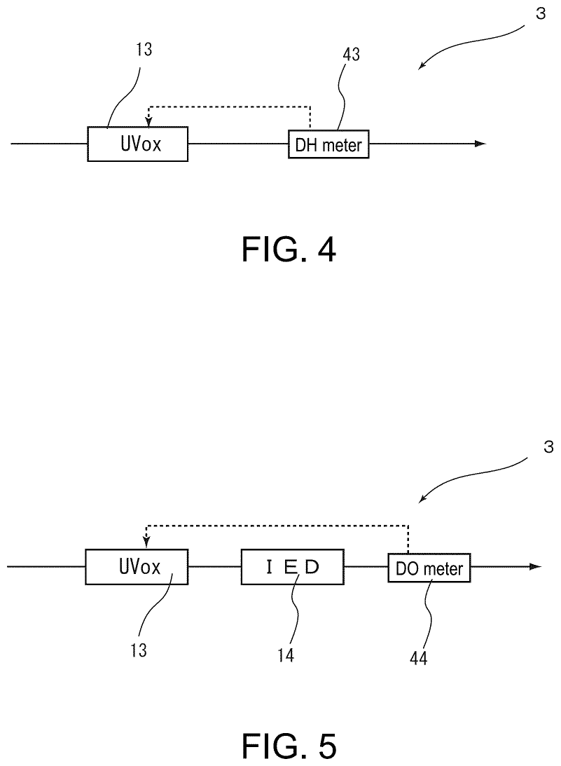

FIG. 4 schematically shows a pure water production device according to the third embodiment of the invention. In this embodiment, a dissolved hydrogen (DH) meter 43 is provided downstream of the ultraviolet oxidation device 13, and a control means (not shown) is provided that may control the amount of ultraviolet rays irradiated in the ultraviolet oxidation device 13 based on the detection value from this DH meter 43. This is because when H₂O₂ is generated, according to the following formula (2)

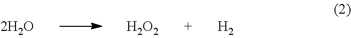

hydrogen (H₂) is generated, and the dissolved hydrogen (DH) also increases.

### (Control Method of Ultraviolet Oxidation Device)

In such a pure water production device, the dissolved hydrogen concentration of the treated water is measured by the DH meter 43 downstream of the ultraviolet oxidation device 13. If the dissolved hydrogen concentration increases or shows an increasing trend, it is determined that the amount of ultraviolet rays irradiated is excessive, and the amount of ultraviolet rays irradiated in the ultraviolet oxidation device 13 is decreased. On the other hand, if the dissolved hydrogen concentration falls below a predetermined level, it is preferable to control the amount of ultraviolet rays irradiated in the ultraviolet oxidation device 13 to decrease. This is because not only is there concern about the residual TOC when the dissolved hydrogen concentration is too low, but especially in an ultrapure water production device 1 as shown in FIG. 1, if the TOC concentration is lowered too much in the ultraviolet oxidation device 13 of the primary pure water device 3, the ultraviolet rays become over-irradiated for TOC in the ultraviolet oxidation device 24 of the subsystem 4, making it easier for H₂O₂ to be generated in the subsystem 4.

### Fourth Embodiment

### (Pure Water Production Device)

FIG. 5 schematically shows a pure water production device according to the fourth embodiment of the present invention. In this embodiment, a dissolved oxygen (DO) meter 44 is provided downstream of the ion exchange device 14 which is provided downstream of the ultraviolet oxidation device 13, and a control means (not shown) is provided which may control the amount of ultraviolet rays irradiated in the ultraviolet oxidation device 13 based on the detection value of this DO meter 44. This is because when H₂O₂ is generated, in the ion exchange device 14, according to the following formula (3)

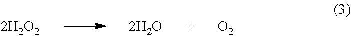

oxygen is released, resulting in an increase in dissolved oxygen (DO).

### (Control Method of Ultraviolet Oxidation Device)

In such a pure water device, the dissolved oxygen concentration of the treated water is measured by the DO meter 44 downstream of the ion exchange device 14. If the dissolved oxygen concentration increases or shows an increasing trend, it is determined that the amount of ultraviolet rays irradiated is excessive, and the amount of ultraviolet rays irradiated in the ultraviolet oxidation device 13 is decreased. On the other hand, if the dissolved oxygen concentration falls below a predetermined level, it is preferable to control the amount of ultraviolet rays irradiated in the ultraviolet oxidation device 13 to decrease.

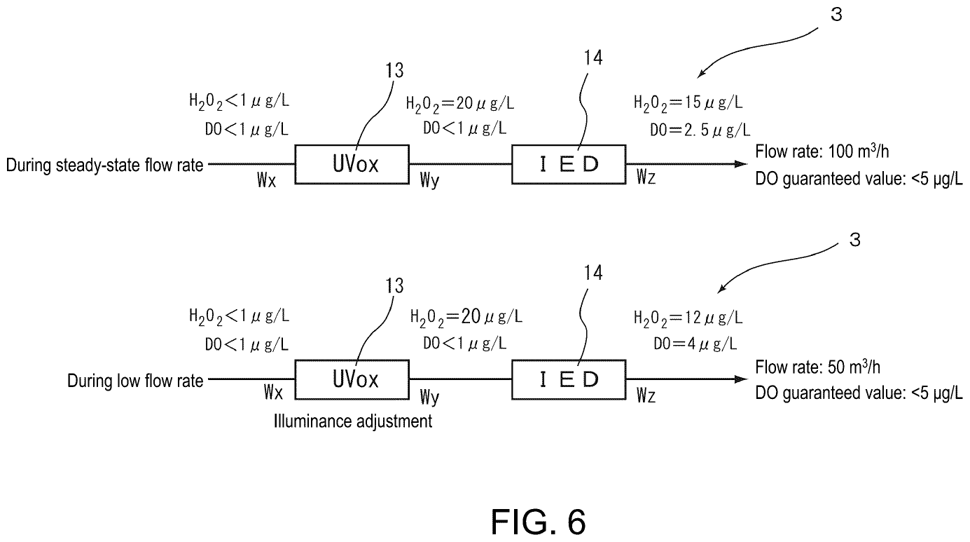

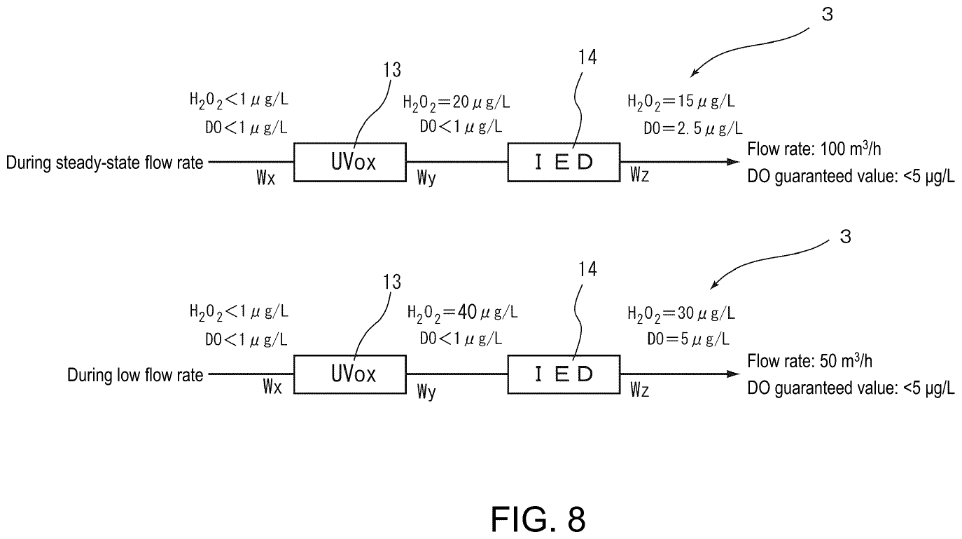

FIG. 6 schematically shows an example of the effect of flow rate fluctuation in the case where the ultraviolet oxidation device 13 is controlled as in the first embodiment to the fourth embodiment described above. This FIG. 6, similar to the previously mentioned FIG. 8, shows a case where the water to be treated Wx is treated by the ultraviolet oxidation device 13 and the ion exchange device 14 to obtain treated water Wz with a guaranteed value of DO<5 μg/L. By adjusting the amount of ultraviolet rays irradiated in the ultraviolet oxidation device 13 during low flow rate (50 m³/h), it is possible to maintain the H₂O₂ in the treated water Wy after treating by the ultraviolet oxidation device 13 at a low level of 20 μg/L, and since there is little impact from the fluctuation in mass balance, the DO of the treated water Wz at the outlet of the ion exchange device 14 becomes <5 μg/L, thus meeting the guaranteed value for DO. It should be noted that during low flow rate, although the DO increases as the SV decreases in the ion exchange device 14, the DO may be maintained at <5 μg/L.

The present invention has been described based on the aforementioned embodiments, but it is not limited to these embodiments and various modification examples are possible. For example, in the fourth embodiment, when hydrogen peroxide flows into the ion exchange device 14, the ion exchange resin decomposes and TOC is generated, so a TOC meter may be provided downstream of the ion exchange device 14, and the amount of ultraviolet rays irradiated in the ultraviolet oxidation device 13 may be controlled based on the detection value of this TOC meter of the ion exchange device 14. In addition, in the ultrapure water production device 1 shown in FIG. 1, the ultraviolet oxidation device 24 of the subsystem 4 may be controlled similarly. Furthermore, the amount of ultraviolet rays irradiated in the ultraviolet oxidation device 13 of the primary pure water device 3 and the amount of irradiation in the ultraviolet oxidation device 24 of the subsystem 4 may be controlled in coordination with each other.

### EXAMPLES

The present invention is described more specifically based on concrete examples as follows.

### [Confirmation Test of Hydrogen Peroxide Generation Amount by Control of Ultraviolet Oxidation Device]

### Examples 1 to 3

Ultrapure water (resistivity: 18.1 MΩ·cm or higher, TOC: <1 μg/L, H₂O₂: <5 μg/L, DO: <5 μg/L, DH: <0.01 μg/L) was prepared, and TOC components were added to this ultrapure water at 10 μg/L, 20 μg/L, and 50 μg/L, respectively, to create test feed water (Examples 1 to 3, respectively).

“JPW” manufactured by Photoscience Japan Corp. was prepared as the ultraviolet oxidation device. This ultraviolet oxidation device has 5 blocks of ultraviolet lamps that may be adjusted for the number of lit blocks, and possesses the capability to adjust the illuminance of the ultraviolet lamps in each block from 30% to 100%.

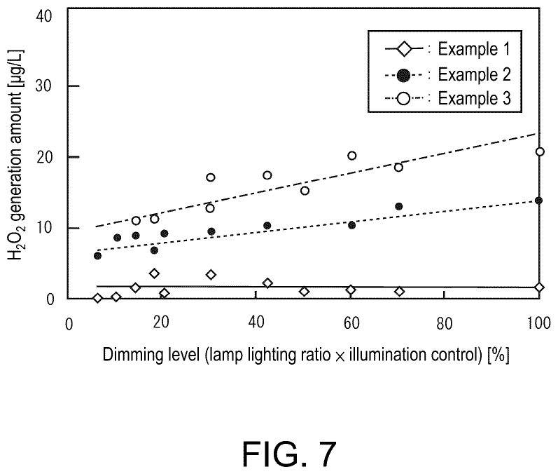

This test feed water was supplied to the ultraviolet oxidation device at a predetermined flow rate, TOC decomposition treatment was performed by adjusting the amount of ultraviolet rays, and generation amount of hydrogen peroxide after treatment was measured for each case. The results are shown in FIG. 7. In this case, the adjustment of the amount of ultraviolet rays was performed by changing the number of lit blocks to 1, 3, and 5 blocks (lamp lighting ratio of 20%, 60%, and 100%), respectively, as well as changing the illuminance dimming ratio to 30%, 50%, 70%, and 100%, respectively, in combination with each other.

As evident from FIG. 7, in Examples 1 to 3, the generation amount of hydrogen peroxide (H₂O₂) changes proportionally by varying the amount of ultraviolet rays. It is seen that by adjusting this amount of ultraviolet rays, the generation amount of hydrogen peroxide (H₂O₂) may be suppressed to approximately 10 μg/L or less.

### REFERENCE SIGNS LIST

1 Ultrapure water production device
2 Pretreatment device
3 Primary pure water device
4 Secondary pure water device (subsystem)
5 Use point
13 Ultraviolet oxidation device
14 Regenerative ion exchange device
24 Ultraviolet oxidation device
25 Platinum group metal catalyst resin tower
41 Flow meter
42 H₂O₂ meter
43 Dissolved hydrogen (DH) meter
44 Dissolved oxygen (DO) meter
W Raw water
W0 Pretreated water
W1 Primary pure water
W2 Secondary pure water (ultrapure water)

1. A pure water production device comprising an ultraviolet oxidation device for treating total organic carbon components in water to be treated, wherein an amount of water to be treated increases or decreases by 5 flow % or more with respect to a set value, and the pure water production device comprises:
a detection means for detecting an index directly or indirectly related to a concentration of H₂O₂ downstream or upstream of the ultraviolet oxidation device; and a control means for controlling an amount of ultraviolet rays in the ultraviolet oxidation device based on a detection value of the detection means.

2. The pure water production device according to claim 1, wherein the detection means is a flow meter, and the control means controls an amount of ultraviolet rays to increase or decrease in response to an increase or a decrease of a flow rate detection value of the flow meter.

3. The pure water production device according to claim 1, wherein the detection means is an H₂O₂ meter or a dissolved hydrogen meter provided downstream of an ultraviolet oxidation device, and the control means controls an amount of ultraviolet rays to increase or decrease in response to an increase or a decrease of a detection value of the H₂O₂ meter or the dissolved hydrogen meter.

4. The pure water production device according to claim 1, wherein the pure water production device comprises an ion exchange device downstream of an ultraviolet oxidation device, the detection means is a dissolved oxygen meter provided downstream of the ion exchange device, and the control means controls an amount of ultraviolet rays to increase or decrease in response to an increase or a decrease of a detection value of the dissolved oxygen meter.

5. The pure water production device according to claim 1, wherein power input per unit flow rate to the ultraviolet oxidation device is 0.01 to 0.3 kWh/m³, and an illuminance of the ultraviolet oxidation device is controllable in a range of 30% to 100% with a maximum value of the illuminance set as 100%.

6. The pure water production device according to claim 1, wherein a total organic carbon measurement means and a flow meter are provided upstream of the ultraviolet oxidation device.
